(19) United States
(12) Patent Application Publication
(10) Pub. No.: US 2020/0309081 A1
(43) Pub. Date: Oct. 1, 2020

(54) AUTOMATIC ENGINE START-STOP BASED ON EXTERNAL CUES

(71) Applicant: LENOVO (Singapore) PTE. LTD., New Tech Park (SG)

(72) Inventors: Nathan J. Peterson, Oxford, NC (US); Mark Patrick Delaney, Raleigh, NC (US); John Carl Mese, Cary, NC (US); Russell Speight VanBlon, Raleigh, NC (US)

(21) Appl. No.: 16/367,201

(22) Filed: Mar. 27, 2019

(51) Int. Cl. F02N 11/08

(52) U.S. Cl. CPC F02N 11/0837; F02N 2200/125

(57) ABSTRACT

Apparatuses, methods, systems, and program products are disclosed for automatic engine start-stop based on external cues. An apparatus includes a processor and a memory that stores code executable by the processor. The memory stores code executable by the processor to detect that an engine for a vehicle is shutdown as part of an engine start-stop system for a vehicle. The memory stores code executable by the processor to collect information related to restarting the engine based on one or more external cues. The memory stores code executable by the processor to automatically restart the engine in response to the information collected based on the one or more external cues satisfying engine restart criteria.

### FIELD

The subject matter disclosed herein relates to automatic engine start-stop, and more particularly relates to using external cues to determine whether to enable the automatic start-stop feature of an engine.

### BACKGROUND

Vehicles may be equipped with features the provide automatic start and shut down of their engines. However, there may be a delay between when a user wants the engine to automatically restart and when the engine actually restarts.

### BRIEF SUMMARY

An apparatus for automatic engine start-stop based on external cues is disclosed. An apparatus, in one embodiment, includes a processor and a memory that stores code executable by the processor. In certain embodiments, the memory stores code executable by the processor to detect that an engine for a vehicle is shutdown as part of an engine start-stop system for a vehicle. One or more auxiliary systems of the vehicle may remain functional while the engine is shutdown. The memory, in further embodiments, stores code executable by the processor to collect information related to restarting the engine based on one or more external cues. The memory, in some embodiments, stores code executable by the processor to automatically restart the engine in response to the information collected based on the one or more external cues satisfying engine restart criteria.

A method for automatic engine start-stop based on external cues includes, in one embodiment, detecting, by a processor, that an engine for a vehicle is shutdown as part of an engine start-stop system for a vehicle. One or more auxiliary systems of the vehicle may remain functional while the engine is shutdown. The method, in some embodiments, includes collecting information related to restarting the engine based on one or more external cues. The method, in various embodiments, includes automatically restarting the engine in response to the information collected based on the one or more external cues satisfying engine restart criteria.

A program product for automatic engine start-stop based on external cues, in one embodiment, includes a computer readable storage medium that stores code executable by a processor. In some embodiments, the executable code includes code to perform detecting that an engine for a vehicle is shutdown as part of an engine start-stop system for a vehicle. One or more auxiliary systems of the vehicle may remain functional while the engine is shutdown. The executable code, in certain embodiments, includes code to perform collecting information related to restarting the engine based on one or more external cues. The executable code, in certain embodiments, includes code to perform automatically restarting the engine in response to the information collected based on the one or more external cues satisfying engine restart criteria.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for automatic engine start-stop based on external cues;

FIG. 2 is a schematic block diagram illustrating one embodiment of an apparatus for automatic engine start-stop based on external cues;

FIG. 3 is a schematic block diagram illustrating one embodiment of another apparatus for automatic engine start-stop based on external cues;

FIG. 4 is a schematic flow chart diagram illustrating one embodiment of a method for automatic engine start-stop based on external cues;

FIG. 5 is a schematic flow chart diagram illustrating one embodiment of another method for automatic engine start-stop based on external cues; and

FIG. 6 is a schematic flow chart diagram illustrating one embodiment of another method for automatic engine start-stop based on external cues.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

An apparatus for automatic engine start-stop based on external cues is disclosed. An apparatus, in one embodiment, includes a processor and a memory that stores code executable by the processor. In certain embodiments, the memory stores code executable by the processor to detect that an engine for a vehicle is shutdown as part of an engine start-stop system for a vehicle. One or more auxiliary systems of the vehicle may remain functional while the engine is shutdown. The memory, in further embodiments, stores code executable by the processor to collect information related to restarting the engine based on one or more external cues. The memory, in some embodiments, stores code executable by the processor to automatically restart the engine in response to the information collected based on the one or more external cues satisfying engine restart criteria.

In one embodiment, the one or more external cues comprise detecting movement of a different vehicle proximate to the vehicle. The movement may be detected using one or more sensors coupled to the vehicle. In certain embodiments, the engine is automatically restarted in response to the movement being detected from a different vehicle located one or more of in front of the vehicle and to a side of the vehicle. In one embodiment, the different vehicle is located at least two vehicle positions in front of the vehicle.

In further embodiments, the one or more external cues comprise detecting that a traffic light changes to indicate that traffic is allowed to proceed in a direction that the vehicle is moving. The engine may automatically be restarted in response to the traffic light change. In various embodiments, the code is further configured to communicate with a traffic control system to receive information that indicates when the traffic light will indicate that traffic is allowed to proceed. In some embodiments, the code is further configured to anticipate when the traffic light will change to indicate that traffic is allowed to proceed based on learned light cycle patterns.

In one embodiment, the one or more external cues comprise determining that a traffic jam that the vehicle is stopped in is moving a distance in front of the vehicle. In various embodiments, the code is further executable by the processor to prevent the engine from automatically shutting down in response to information collected from the one or more external cues. In certain embodiments, the one or more external cues comprise determining that a traffic signal will change to indicate that traffic is allowed to proceed within a threshold time period.

In one embodiment, the one or more external cues comprise determining that the vehicle is a lane that allows vehicles to proceed even when a traffic signal indicates that traffic is stopped. In further embodiments, the one or more external cues comprise determining that the vehicle is stopped at a stop sign. In some embodiments, the code is further executable by the processor to prevent the engine from automatically restarting in response to the information collected from the one or more external cues indicating an obstruction in front of the vehicle. In one embodiment, restarting the engine comprises restarting one or more cylinders of the engine that were disabled during engine shutdown.

A method for automatic engine start-stop based on external cues includes, in one embodiment, detecting, by a processor, that an engine for a vehicle is shutdown as part of an engine start-stop system for a vehicle. One or more auxiliary systems of the vehicle may remain functional while the engine is shutdown. The method, in some embodiments, includes collecting information related to restarting the engine based on one or more external cues. The method, in various embodiments, includes automatically restarting the engine in response to the information collected based on the one or more external cues satisfying engine restart criteria.

In one embodiment, the one or more external cues comprise detecting movement of a different vehicle proximate to the vehicle. The movement may be detected using one or more sensors coupled to the vehicle. In various embodiments, the engine is automatically restarted in response to the movement being detected from a different vehicle located one or more of in front of the vehicle and to a side of the vehicle.

In certain embodiments, the one or more external cues comprise detecting that a traffic light changes to indicate that traffic is allowed to proceed in a direction that the vehicle is moving. The engine may automatically be restarted in response to the traffic light change. In further embodiments, the method includes communicating with a traffic control system to receive information that indicates when the traffic light will indicate that traffic is allowed to proceed.

A program product for automatic engine start-stop based on external cues, in one embodiment, includes a computer readable storage medium that stores code executable by a processor. In some embodiments, the executable code includes code to perform detecting that an engine for a vehicle is shutdown as part of an engine start-stop system for a vehicle. One or more auxiliary systems of the vehicle may remain functional while the engine is shutdown. The executable code, in certain embodiments, includes code to perform collecting information related to restarting the engine based on one or more external cues. The executable code, in certain embodiments, includes code to perform automatically restarting the engine in response to the information collected based on the one or more external cues satisfying engine restart criteria.

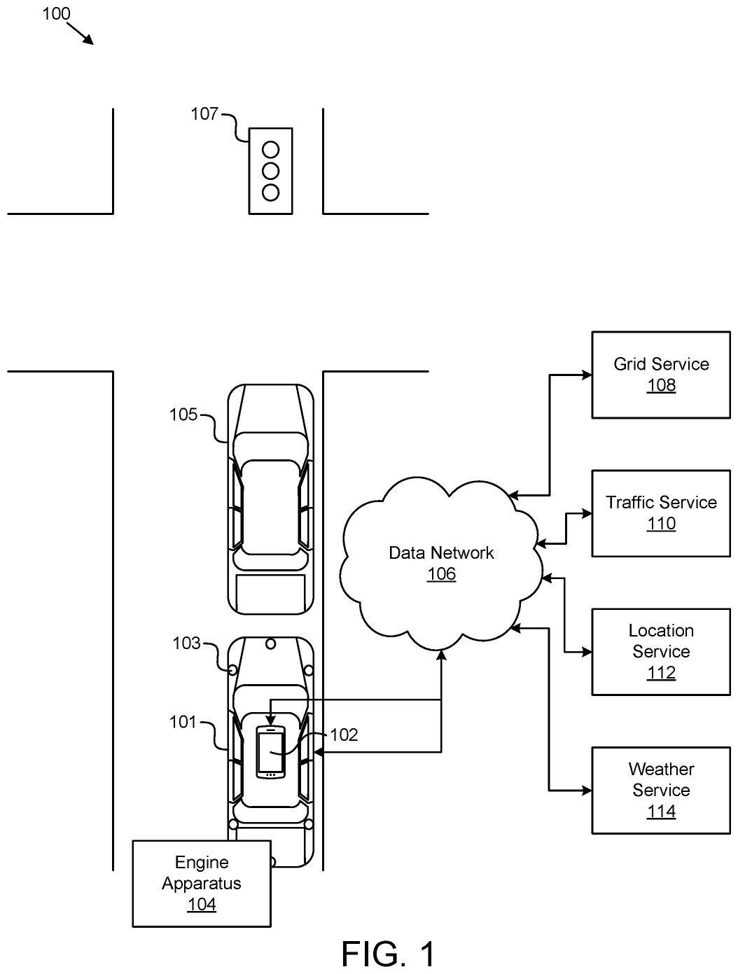

FIG. 1 is a schematic block diagram illustrating one embodiment of a system 100 for automatic engine start-stop based on external cues. In one embodiment, the system 100 includes one or more vehicles 101/105, one or more information handling devices 102, one or more sensors 103, one or more engine apparatuses 104, one or more data networks 106, one or more traffic signals 107, and one or more services such as grid services 108, traffic services 110, location services 112, and/or weather services 114. In certain embodiments, even though a specific number of the foregoing components are depicted in FIG. 1, one of skill in the art will recognize, in light of this disclosure, that any number of components may be included in the system 100.

In one embodiment, the system 100 includes one or more vehicles 101/105. The vehicles 101/105 may comprise cars, trucks, sport-utility vehicles, semi-trucks, motorcycles, boats or other watercraft, and/or the like. The vehicles 101/105 may be equipped with an engine and system that allows for automatic start-stop. As used herein, an automatic start-stop system for a vehicle 101/105 automatically shuts down and restarts the engine based on different parameters or settings. In certain embodiments, the start-stop system selectively shuts down and restarts components of the engine such as one or more cylinders. This reduces the amount of time that the engine is idling thereby reducing fuel consumption, emissions, etc. For example, in conventional start-stop systems, when a car pulls up to a red light and the user holds his foot on the brake, the engine may be shut down until the user removes his foot from the brake, which may trigger restarting the engine, and applies it to the gas to get the vehicle 101 moving again. While the engine is shutdown as part of the start-stop system, the auxiliary systems of the vehicle 101 remain functional such as the electrical systems, the climate control systems, and/or the like. In certain embodiments, the vehicles 101/105 have internal combustion engines such as gas engines, diesel engines, hybrid engines (e.g., a combination of electric and internal combustion), and/or the like.

In one embodiment, the vehicle 101 is equipped with various sensors 103 for detecting, sensing, and/or collecting data related to the vehicle's external environment. For instance, the sensors 103 may include proximity sensors for detecting objects, e.g., other vehicles 105, pedestrians, or the like that are within a proximity of a front, rear, or side of the vehicle 101. Other sensors may include cameras, light sensors, moisture sensors, and/or the like. The vehicle 101 may include sensors 103 for communicating with other vehicles 105 to send and receive information associated with the vehicle 105, such as diagnostic information, speed information, traffic information, engine information, and/or the like.

In one embodiment, the system 100 includes one or more information handling devices 102, which may be located within a vehicle 101, e.g., such as the driver's smart phone, and wirelessly connected to the vehicle 101 over a short-range wireless network, e.g., Bluetooth® or connected to the vehicle 101 over a wired connection, e.g., a USB connection. The information handling devices 102 may include a mobile device such as a a laptop computer, a tablet computer, a smart phone, a smart watch, a fitness band or other wearable activity tracking device, an optical head-mounted display (e.g., a virtual reality headset, smart glasses, or the like), a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium.

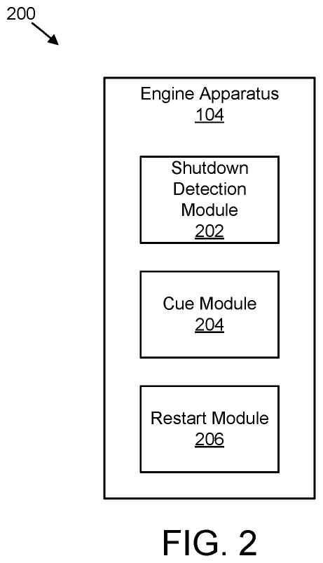

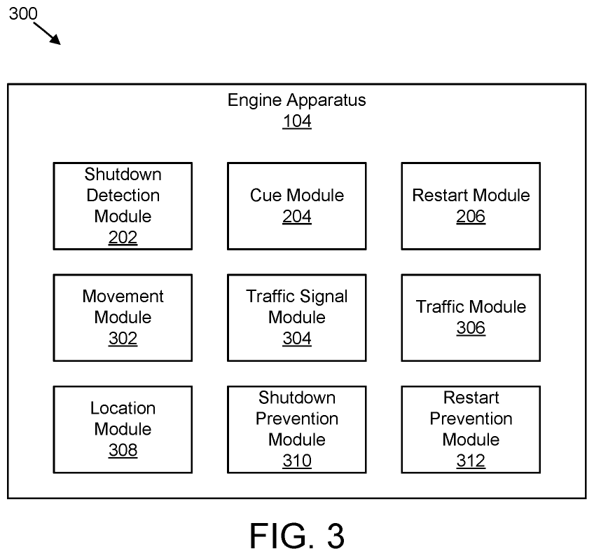

In one embodiment, the engine apparatus 104 is configured to automatically start the vehicle's engine as part of a start-stop system after the engine has been shutdown in response to information related to various external cues that the sensors 103 detect or other information that the vehicle 101 and/or the information handling device 102 receives. In one embodiment, the engine apparatus 104 detects that an engine for a vehicle 101 is shutdown as part of a start-stop system. The engine apparatus 104 may collect information related to restarting the engine based on one or more external cues and automatically restart the engine in response to the information collected based on the one or more external cues satisfying engine restart criteria. The engine apparatus 104, including its various sub-modules, may be located on a vehicle 101, on one or more information handling devices 102 in the system 100, on one or more network devices, and/or the like. The engine apparatus 104 is described in more detail below with reference to FIGS. 2 and 3.

In one embodiment, the engine apparatus 104 improves upon conventional start-stop engine systems because it provides for earlier or anticipated restart of the engine based on external cues instead of merely keying off of a driver removing his foot from the brake or applying his foot to the gas pedal. Furthermore, the engine apparatus 104 receives information from external cues that is analyzed and process to determine whether the engine should not be shutdown when it normally would be under conventional engine start-stop systems.

In various embodiments, the engine apparatus 104 may be embodied as a hardware appliance that can be installed or deployed on an information handling device 102, on a vehicle 101, or elsewhere on the data network 106. In certain embodiments, the engine apparatus 104 may include a hardware device such as a secure hardware dongle or other hardware appliance device that attaches to a device such as a vehicle computer, a laptop computer, a tablet computer, a smart phone, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the engine apparatus 104 may include a power interface, a wired and/or wireless network interface, a graphical interface that attaches to a display, and/or a semiconductor integrated circuit device as described below, configured to perform the functions described herein with regard to the engine apparatus 104.

The engine apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the engine apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the engine apparatus 104.

The semiconductor integrated circuit device or other hardware appliance of the engine apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the engine apparatus 104 includes and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

In certain embodiments, the information handling device 102 and/or an internal computing device for the vehicle 101 is wirelessly connected to a data network 106. The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

In certain embodiments, the traffic control signal 107 may comprise a traffic light (e.g., a stop light comprising red, yellow, and green lights) that is used to control flows of traffic. The traffic control signal 107 may be operably connected to a traffic control grid that is controlled by a traffic grid service 108. The grid service 108 may monitor and maintain a plurality of traffic control signals 107 and other traffic control means. The grid service 108 may be part of a traffic control center for a region or city and may provide an application programming interface (“API”) or other access to traffic control information, e.g., the traffic light signal cycle or pattern for a particular intersection, or the like), which the engine apparatus 104 can use to determine when to restart the engine.

Similarly, the traffic service 110 may provide traffic information to the engine apparatus 104, which can be used to determine when to restart the engine. The traffic information may comprise information from the traffic grid system, crowdsourced traffic information from services such as Waze®, and/or the like that can notify the engine apparatus 104 when traffic is moving, if traffic is stopping, traffic start-stop intervals, and/or the like.

The location service 112 may provide information related to starting and stopping the engine based on the vehicle's location. The location service 112 may be a mapping service, a GPS system, and/or the like. The location service 112 may provide information such as upcoming construction zones, accidents, hazardous areas or areas that may be difficult to maneuver, and/or the like, which the engine apparatus 104 may use to determine whether to start or stop the engine.

The weather service 114 may provide weather-related information for the user such as temperatures, precipitation, forecasts, and/or the like. The engine apparatus 104 may use the weather related information to determine whether to start or stop the engine (e.g., if temperatures are extremely low, then the engine apparatus 104 may not turn the engine off because it may be difficult to restart due to the low temperatures).

FIG. 2 is a schematic block diagram illustrating one embodiment of an apparatus 200 for automatic engine start-stop based on external cues. In one embodiment, the apparatus 200 includes an embodiment of an engine apparatus 104. The engine apparatus 104, in some embodiments, includes one or more of a shutdown detection module 202, a cue module 204, and a restart module 206, which are described in more detail below.

In one embodiment, the shutdown detection module 202 is configured to detect that an engine, or one or more components that drive the engine (e.g., cylinders), for a vehicle 101 is shutdown as part of an engine start-stop system, as described above. In such an embodiment, the shutdown detection module 202 may receive a signal, message, notification, or the like that indicates that the engine is not running. The shutdown detection module 202, in some embodiment, may use sensor data to detect that the engine is shutdown. For instance, the shutdown detection module 202 may detect that the engine is shut down based on detecting that a dashboard indicator light is enabled when the engine is shutdown, in response to detecting no exhaust coming out of an exhaust pipe, in response to detecting no sound or vibrations coming from the engine, and/or the like.

In one embodiment, the cue module 204 is configured to collect information related to restarting the engine based on one or more external cues. The cue module 204, for instance, may communicate with the sensors 103 and/or services 108-114 to receive, collect, store, track, and/or the like environmental data that may affect the decision to restart the engine such as information for and/or from other vehicles 105 that are proximate to the user's vehicle 101, traffic data, weather data, location-aware data, and/or the like.

In one embodiment, the restart module 206 is configured to automatically restart the engine, or components of the engine that have been shut down (e.g., cylinders), as part of the start-stop system of the vehicle 101 in response to the information from the external cues satisfying an engine restart criteria. As used herein, engine restart criteria may comprise various situations described below related to anticipation of the user's vehicle 101 being able to proceed or move soon. In such an embodiment, the restart module 206 may override the standard engine start-stop system programming for the vehicle 101 and restart the engine before the start-stop system would conventionally restart the engine.

For example, if a user pulls up to a red light at an intersection (indicating to stop to allow traffic from other directions through the intersection), the start-stop system of the vehicle 101 may shut the engine, or components of the engine, down (while leaving auxiliary components running such as electrical systems, climate control systems, etc.). The shutdown detection module 202, in one embodiment, detects that the engine, or components of the engine, is shut down and the cue module 204 may begin tracking external information that can be used to determine when to restart the engine, or components of the engine. For instance, the cue module 204 may use camera information to determine when the traffic light 107 turns green (indicating to allow traffic to go through the intersection in the user's direction), determine when nearby vehicles 105 begin moving, and/or the like. In response to the external information indicating that traffic will begin moving soon, the restart module 206 may restart the engine, or components of the engine. In this manner, the amount of lag, jerkiness, or the like can be reduced or avoided by using external cues to decide to start the engine, or components of the engine earlier than the conventional determination, which is usually just detecting when the user removes his foot from the brake.

FIG. 3 is a schematic block diagram illustrating one embodiment of an apparatus 300 for automatic engine start-stop based on external cues. In one embodiment, the apparatus 300 includes an embodiment of an engine apparatus 104. The engine apparatus 104, in some embodiments, includes one or more of a shutdown detection module 202, a cue module 204, and a restart module 206, which may be substantially similar to the shutdown detection module 202, the cue module 204, and the restart module 206 described above with reference to FIG. 2. In further embodiments, the engine apparatus 104 includes one or more of a movement module 302, a traffic signal module 304, a traffic module 306, a location module 308, a shutdown prevention module 310, and a restart prevention module 312, which are described in more detail below.

In one embodiment, the movement module 302 is configured to detect movement of a different vehicle 105 proximate to the user's vehicle 101 in response to or based on movement that the cue module 204 detects using various sensors 103. For instance, the movement module 302 may detect that a vehicle 105 stopped in front of the user's vehicle 101 starts moving based on motion and/or proximity sensors 103 or a camera mounted to the vehicle 101. In such an embodiment, the restart module 206 may use the movement information as an indication that traffic is moving and will restart the vehicle's engine, or components of the engine.

Accordingly, in certain embodiments, the movement module 302 may detect when vehicles 105 begin moving in front of or next to the user's vehicle 101. The movement module 302 may detect when an adjacent vehicle 105 begins moving or when a vehicle 105 two or more vehicle positions in front of or next to the user's vehicle begin to move, e.g., based on camera data or other sensor information.

The movement module 302 may determine the distance that the proximate or adjacent vehicles 105 move before determining that traffic is beginning to flow. For instance, if the other vehicle 105 is just creeping up a little bit, then traffic may still be stopped; however, if the other vehicle 105 moves a certain distance such as a foot or more then the movement module 302 may determine that the vehicle 105 is moving with traffic. Accordingly, the movement module 302 may trigger or signal the restart module 206 to restart the engine, or components of the engine.

In one embodiment, the traffic signal module 304 is configured to detect that a traffic light/signal 107 changed or will change to indicate that traffic is allowed to proceed in a direction the that user's vehicle 101 is moving. In such an embodiment, the traffic signal module 304 may communicate with a traffic control grid system service 108 to get information regarding the traffic light cycles or patterns for the intersection or road where the user's vehicle 101 is located. For instance, the grid service 108 may indicate that the traffic light 107 will change from red to green in ten seconds.

In certain embodiments, the traffic signal module 304 is configured to learn, over time, the light cycles or patterns of the traffic signals 107 at certain intersections or roads. In such an embodiment, the traffic signal module 304 may use machine learning algorithms and/or models that are trained on traffic signal data for the area where the user's vehicle 101 is located to anticipate, forecast, or predict when the traffic light will change to stop or allow traffic to flow. Current traffic signal information may be collected using cameras (e.g., video or pictures of the traffic signal 107) or other sensors (e.g., infrared sensors). The signal information may be input into the machine learning algorithms to predict when the traffic signal 107 will change. Based on the predictions, the restart module 206 may restart the engine, or components of the engine, at the point when the traffic signal 107 is predicted or anticipated to change.

In one embodiment, the traffic module 306 is configured to determine traffic conditions for an area where the user's vehicle is located 101. For instance, if a user is stuck in a traffic jam, the traffic module 306 may query traffic information from social media, from a department of transportation website/service (e.g., traffic service 110), from a crowdsource traffic application (e.g., Waze®), or the like to determine if traffic is moving, an anticipated time for traffic to begin moving, and/or the like.

For example, the traffic module 306 may communicate with a state department of transportation traffic service 110 to determine the expected wait time at a particular traffic jam, traffic accident, etc. Based on the wait time, the restart module 206 may restart the engine at the anticipate or expected time for traffic to begin moving. In certain embodiments, described below, the traffic information may also be used to determine whether the prevent the engine, or components of the engine, from shutting down, for instance, if traffic is stop and go with small intervals between stopping and going, then it may not be efficient or effective to continuously shut down and restart the engine, or components of the engine.

In one embodiment, the location module 308 is configured to determine the location for the user's vehicle 101 and determine any factors related to the vehicle's location that may affect restarting the vehicle's engine. The location module 308 may determine the vehicle's location based on the vehicle's or the information handling device's GPS sensors, triangulation using cellular network towers, mapping services, and/or the like. The location module 308 may then provide the location to the traffic signal module 304, the traffic module 306, and/or the like to be used to determine the intersection or road that the user is on and any traffic light information and/or traffic information for the user's location.

In one embodiment, the shutdown prevention module 310 is configured to prevent the vehicle's engine from automatically shutting down during the automatic engine start-stop based on or in response to information collected for the one or more external cues. For instance, if the traffic signal module 304 determines that a traffic signal 107 will change to indicate that traffic is allowed to proceed within a threshold period of time, the shutdown prevention module 310 may prevent the engine from automatically shutting down even though the user is stopped at the traffic signal. The threshold period of time may be a second, five seconds, thirty seconds, minutes, and/or the like.

In a further embodiment, the location module 308 may determine that the user's vehicle 101 is located in a turn lane that allows vehicles 101/105 to turn even when a traffic signal 107 indicates that traffic is stopped or not allowed to proceed. For instance, the location module 308 may determine that the user's vehicle is located in a right turn lane that allows right turns on red lights, but the user is stopped at the red light waiting for an opportunity to turn right. Because the user will be turning soon, the shutdown prevention module 310 may prevent the engine start-stop system from automatically shutting the engine, or components of the engine, down prior to the user turning.

In certain embodiments, the location module 308 may determine that the user's vehicle 101 is stopped at a stop sign. Because a stop at a stop sign typically only lasts a few seconds at most, the shutdown prevention module 310 may prevent the engine start-stop system from automatically shutting the engine, or components of the engine, down prior to the user proceeding through the stop sign. One of skill in the art will recognize other traffic situations where the user is stopped for only a brief moment prior to moving, which may trigger the shutdown prevention module 310 to prevent the engine start-stop system from automatically shutting the engine, or components of the engine, down.

The restart prevention module 312, in one embodiment, is configured to prevent the engine, or components of the engine, from automatically restarting in response to the information collected from the one or more external cues indicating an obstruction in front of the vehicle 101. For instance, if the vehicle 101 is stopped at a crosswalk and the user takes his foot off the brake, but the restart prevention module 312 detects (using the sensors 103) a pedestrian, an animal, or other obstruction in front of the vehicle 101, the restart prevention module 312 may prevent the engine, or components of the engine, from restarting to prevent the vehicle 101 from moving forward. Similarly, if the user is stopped at an intersection and there is another vehicle 105 in front of the user's vehicle 101, and the user accidentally takes his foot off the brake, the restart prevention module 312 may detect the vehicle 105 directly in front of the user's vehicle 101 and prevent the engine, or components of the engine, from restarting so that the user's vehicle 101 does not move forward.

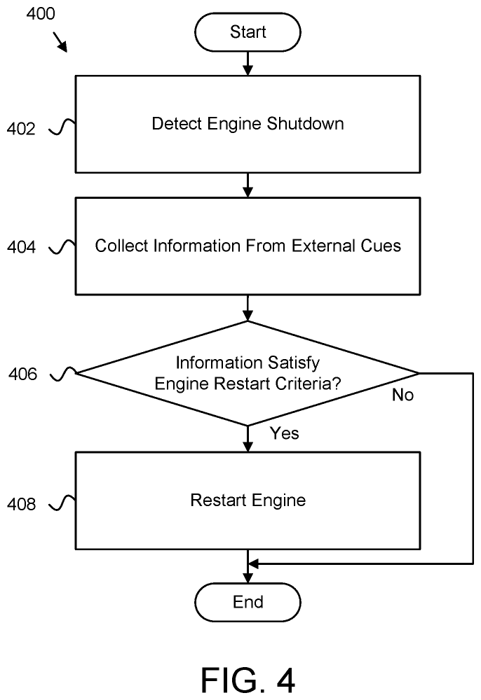

FIG. 4 is a schematic flow chart diagram illustrating one embodiment of a method 400 for automatic engine start-stop based on external cues. In one embodiment, the method 400 begins and detects 402 that an engine, or components of the engine, for a vehicle 101 is shutdown as part of an engine start-stop system for a vehicle 101. The method 400, in certain embodiments, collects 404 information related to restarting the engine, or components of the engine, based on one or more external cues. In some embodiments, the method 400 determines 406 if the information from the one or more external cues satisfy restart criteria, e.g., whether the information indicates that the user's vehicle 101 will be able to move or proceed soon. If so, the method 400 automatically restarts 408 the engine, or components of the engine, and the method 400 ends. In various embodiments, the shutdown detection module 202, the cue module 204, and the restart module 206 perform the various steps of the method 400.

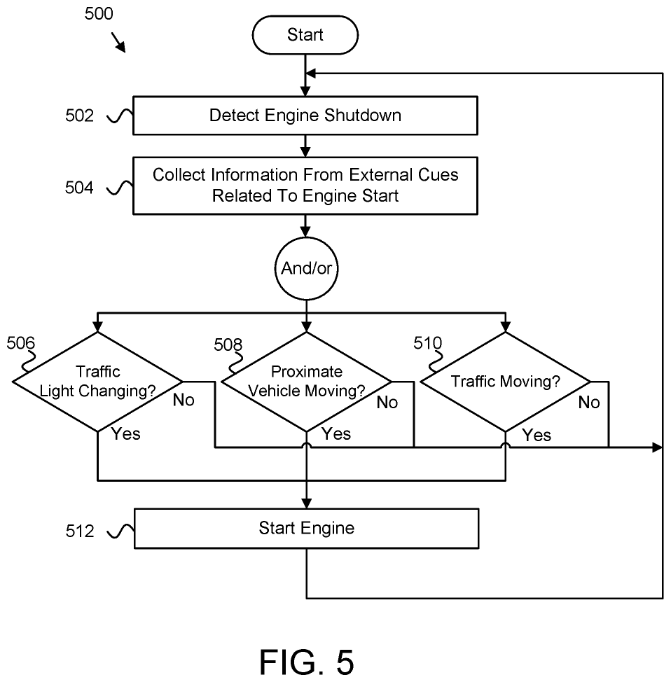

FIG. 5 is a schematic flow chart diagram illustrating one embodiment of another method 500 for automatic engine start-stop based on external cues. In one embodiment, the method 500 begins and detects 502 that an engine, or components of the engine, for a vehicle 101 is shutdown as part of an engine start-stop system for a vehicle 101. The method 500, in certain embodiments, collects 504 information related to restarting the engine, or components of the engine, based on one or more external cues.

In further embodiments, the method 500 determines whether the information satisfies various criteria. For instance, in one embodiment, the method 500 determines 506 whether a traffic light 107 is changing to allow traffic through an intersection in the user's direction, determines 508 whether a vehicle 105 that is adjacent to the user's vehicle 101 is moving, and/or determines 510 whether traffic ahead of the user's vehicle 101 is moving. If not, the method 500 may continue to detect 502 whether the engine, or components of the engine, has been shut down.

Otherwise, the method 500 may start 512 the vehicle's engine. The method 500 may continue to detect 502 whether the engine, or components of the engine, has been shut down. In various embodiments, the shutdown detection module 202, the cue module 204, and the restart module 206 perform the various steps of the method 500.

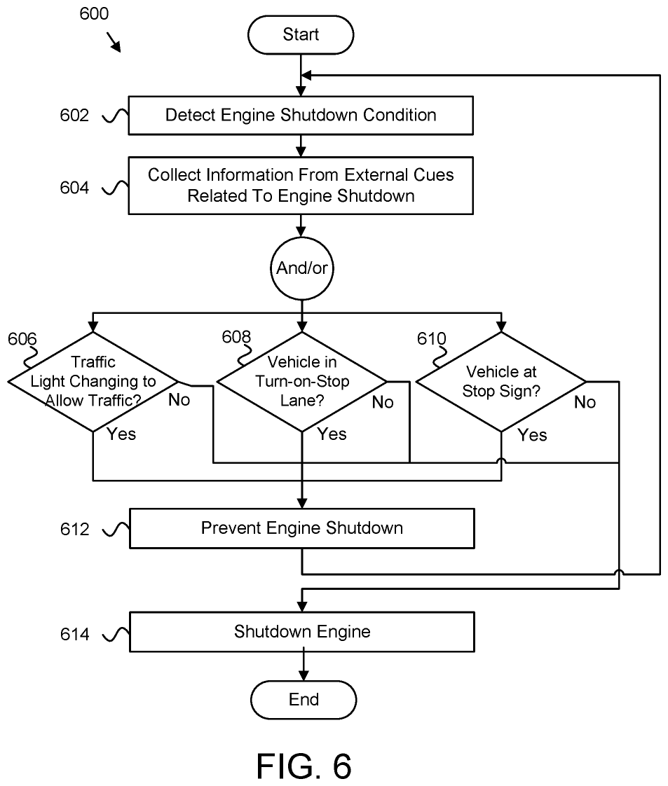

FIG. 6 is a schematic flow chart diagram illustrating one embodiment of another method 600 for automatic engine start-stop based on external cues. In one embodiment, the method 600 begins and detects 602 an engine shutdown condition (e.g., the user stopping for a period of time at a red light, a stop sign, traffic congestion, etc.) as part of the engine start-stop system. The method 600 may collect 604 information related to restarting the engine, or components of the engine, based on one or more external cues.

In certain embodiments, the method 600 determines various engine shutdown prevention situations. For instance, the method 600 may determine 606 whether a traffic light is changing soon to allow traffic through an intersection in the user's direction, may determine 608 whether the vehicle 101 is in a turn lane that allows vehicles 101/105 to proceed even when a traffic signal indicates that traffic is stopped, and/or may determine 610 whether the vehicle 101 is stopped at a stop sign.

If so, the method 600 may prevent 612 the engine, or components of the engine, from being shut down and may continue to detect 602 an engine shutdown condition. Otherwise, the method 600 may shut 614 the engine down, and the method 600 ends. In various embodiments, the shutdown detection module 202, the cue module 204, and the shutdown prevention module 310 perform the various steps of the method 600.

Embodiments may be practiced in other specific forms. The described embodiments are to be considered in all respects only as illustrative and not restrictive. The scope of the subject matter disclosed herein is, therefore, indicated by the appended claims rather than by the foregoing description. All changes which come within the meaning and range of equivalency of the claims are to be embraced within their scope.

1. An apparatus comprising:
a processor; and
a memory that stores code executable by the processor to:
detect that an engine for a vehicle is shutdown as part of an engine start-stop system for a vehicle, wherein one or more auxiliary systems of the vehicle remain functional while the engine is shutdown;
collect information related to restarting the engine based on one or more external cues, the one or more external cues comprising detecting movement of a different vehicle proximate to the vehicle, the movement detected using one or more sensors coupled to the vehicle;
determine an amount of distance of the movement of the different vehicle proximate to the vehicle; and
automatically restart the engine in response to the amount of distance of the movement of the different vehicle satisfying a predefined distance.

2. (canceled)

3. The apparatus of claim 1, wherein the engine is automatically restarted in response to the movement being detected from a different vehicle located one or more of in front of the vehicle and to a side of the vehicle.

4. The apparatus of claim 3, wherein the different vehicle is located at least two vehicle positions in front of the vehicle.

5. The apparatus of claim 1, wherein the one or more external cues comprise detecting that a traffic light changes to indicate that traffic is allowed to proceed in a direction that the vehicle is moving, the engine automatically being restarted in response to the traffic light change.

6. The apparatus of claim 5, wherein the code is further configured to communicate with a traffic control system to receive information that indicates when the traffic light will indicate that traffic is allowed to proceed.

7. The apparatus of claim 5, wherein the code is further configured to anticipate when the traffic light will change to indicate that traffic is allowed to proceed based on learned light cycle patterns.

8. The apparatus of claim 1, wherein the one or more external cues comprise determining that a traffic jam that the vehicle is stopped in is moving a distance in front of the vehicle.

9. The apparatus of claim 1, wherein the code is further executable by the processor to prevent the engine from automatically shutting down in response to information collected from the one or more external cues.

10. The apparatus of claim 9, wherein the one or more external cues comprise determining that a traffic signal will change to indicate that traffic is allowed to proceed within a threshold time period.

11. The apparatus of claim 9, wherein the one or more external cues comprise determining that the vehicle is a lane that allows vehicles to proceed even when a traffic signal indicates that traffic is stopped.

12. The apparatus of claim 9, wherein the one or more external cues comprise determining that the vehicle is stopped at a stop sign.

13. The apparatus of claim 1, wherein the code is further executable by the processor to prevent the engine from automatically restarting in response to the information collected from the one or more external cues indicating an obstruction in front of the vehicle.

14. The apparatus of claim 1, wherein restarting the engine comprises restarting one or more cylinders of the engine that were disabled during engine shutdown.

15. A method comprising:
detecting, by a processor, that an engine for a vehicle is shutdown as part of an engine start-stop system for a vehicle, wherein one or more auxiliary systems of the vehicle remain functional while the engine is shutdown;
collecting information related to restarting the engine based on one or more external cues, the one or more external cues comprising detecting movement of a different vehicle proximate to the vehicle, the movement detected using one or more sensors coupled to the vehicle;
determining an amount of distance of the movement of the different vehicle proximate to the vehicle; and
automatically restarting the engine in response to the amount of distance of the movement of the different vehicle satisfying a predefined distance.

16. (canceled)

17. The method of claim 15, wherein the engine is automatically restarted in response to the movement being detected from a different vehicle located one or more of in front of the vehicle and to a side of the vehicle.

18. The method of claim 15, wherein the one or more external cues comprise detecting that a traffic light changes to indicate that traffic is allowed to proceed in a direction that the vehicle is moving, the engine automatically being restarted in response to the traffic light change.

19. The method of claim 18, further comprising communicating with a traffic control system to receive information that indicates when the traffic light will indicate that traffic is allowed to proceed.

20. A program product comprising a computer readable storage medium that stores code executable by a processor, the executable code comprising code to perform:
detecting that an engine for a vehicle is shutdown as part of an engine start-stop system for a vehicle, wherein one or more auxiliary systems of the vehicle remain functional while the engine is shutdown;
collecting information related to restarting the engine based on one or more external cues, the one or more external cues comprising detecting movement of a different vehicle proximate to the vehicle, the movement detected using one or more sensors coupled to the vehicle;
determining an amount of distance of the movement of the different vehicle proximate to the vehicle; and
automatically restarting the engine in response to the amount of distance of the movement of the different vehicle satisfying a predefined distance.

21. The apparatus of claim 7, wherein the light cycle patterns are learned by inputting traffic signal information into a machine learning algorithm to generate predictions about when the traffic signal will change.

22. The method of claim 18, further comprising anticipating when the traffic light will change to indicate that traffic is allowed to proceed based on learned light cycle patterns, the light cycle patterns learned by inputting traffic signal information into a machine learning algorithm to generate predictions about when the traffic signal will change.
